(19) United States
(12) Patent Application Publication
(10) Pub. No.: US 2022/0261630 A1
(43) Pub. Date: Aug. 18, 2022

(54) LEVERAGING DYNAMICAL PRIORS FOR SYMBOLIC MAPPINGS IN SAFE REINFORCEMENT LEARNING

(71) Applicant: INTERNATIONAL BUSINESS MACHINES CORPORATION, Armonk, NY (US)

(72) Inventors: Nathaniel Ryan Fulton, Cambridge, MA (US); Subhro Das, Cambridge, MA (US); Nathan Hunt, Cambridge, MA (US); Trong Nghia Hoang, Cambridge, MA (US)

(21) Appl. No.: 17/179,015

(22) Filed: Feb. 18, 2021

(51) Int. Cl. G06N 3/08; G06N 3/04

(52) U.S. Cl. CPC G06N 3/08; G06N 3/04

(57) ABSTRACT

Embodiments of the disclosure provide a reinforcement learning model configured to receive state data (e.g., image state data) and determine candidate actions (e.g., environment navigation actions, environment modification actions, etc.) based on the received state data. Embodiments of the disclosure further provide an object detector configured to generate symbolic state data (e.g., safety relevant data) from the state data. Accordingly, as described herein, a safety system can update a dynamical safety constraint based on the symbolic state data, as well as filter the actions determined by the reinforcement learning model and select an action to be executed based on the dynamical safety constraint. For instance, the safety system classifies each action (e.g., each candidate action determined by the reinforcement learning model) in each symbolic state as either “safe” or “not safe” based on the dynamical safety constraint (e.g., and a safe action may be selected and executed).

### STATEMENT REGARDING PRIOR DISCLOSURES BY THE INVENTOR OR A JOINT INVENTOR

This application relates to a prior disclosure made available to the public on Jul. 2, 2020, entitled VERIFIABLY SAFE EXPLORATION FOR END-TO-END REINFORCEMENT LEARNING, at https://arxiv.org/abs/2007.01223. The contents of the foregoing prior disclosure are hereby incorporated by reference for all purposes.

### BACKGROUND

The following relates generally to reinforcement learning, and more specifically to safe reinforcement learning based on object detection.

In some cases, vision based safety systems implement reinforcement learning models to interact with an environment to learn the environment and perform tasks (e.g., actions) within the environment. Such systems may be subject to safety constraints (e.g., such as systems in autonomous vehicles, in manufacturing plant environments, etc.) that specify and enforce safe actions in settings with visual inputs by combining object detectors with formally verified safety guards. Recently, vision based safety systems have used deep reinforcement learning algorithms that are effective at learning, from raw image data, control policies that optimize a quantitative reward signal aligned with safety constraints.

However, learning such safety policies may require large (e.g., unrealistic) amounts of training data, may require experiencing of many (e.g., millions of) unsafe actions, may require full symbolic characterization of the environment and precise observance of entire states, etc. These techniques are thus not realistic for actual robotic systems which have to interact with the physical world and can only perceive environments through an imperfect visual system. Therefore, there is a need in the art for improved vision based safety systems that are efficient and scalable to real world applications.

### SUMMARY

The present disclosure describes systems and methods for vison based safety systems. Embodiments of the disclosure provide a reinforcement learning model configured to receive state data (e.g., image state data) and determine candidate actions (e.g., environment navigation actions, environment modification actions, etc.) based on the received state data. Embodiments of the disclosure further provide an object detector configured to generate symbolic state data (e.g., safety relevant data) from the state data. Accordingly, as described herein, a safety system can update a dynamical safety constraint based on the symbolic state data, as well as filter the actions determined by the reinforcement learning model and select an action to be executed based on the dynamical safety constraint. For instance, the safety system classifies each action (e.g., each candidate action determined by the reinforcement learning model) in each symbolic state as either “safe” or “not safe” based on the dynamical safety constraint (e.g., and a safe action may be selected and executed to modify or navigate the environment).

A method, apparatus, non-transitory computer readable medium, and system for object detection using safe reinforcement learning are described. Embodiments of the method, apparatus, non-transitory computer readable medium, and system are configured to receive state data for a reinforcement learning model interacting with an environment, detect an object in the environment based on the state data, update a dynamical safety constraint corresponding to the object based on the state data, and select an action based on the state data, the reinforcement learning model, and the dynamical safety constraint.

An apparatus, system, and method for object detection using safe reinforcement learning are described. Embodiments of the apparatus, system, and method are configured to a reinforcement learning model configured to receive state data and to select one or more actions based on the state data, an object detector configured to generate symbolic state data based on the state data, the symbolic state data including an object, and a safety system configured to update a dynamical safety constraint based on the symbolic state data and to filter the actions based on the dynamical safety constraint.

A method, apparatus, non-transitory computer readable medium, and system for object detection using safe reinforcement learning are described. Embodiments of the method, apparatus, non-transitory computer readable medium, and system are configured to receive state data for a reinforcement learning model interacting with an environment, update a dynamical safety constraint based on the state data, select an action based on the state data, the reinforcement learning model, and the dynamical safety constraint, compute a reward based on the action, and train the reinforcement learning model based on the reward.

### BRIEF DESCRIPTION OF THE DRAWINGS

FIG. 1 shows an example of an object detection system according to aspects of the present disclosure.

FIG. 2 shows an example of a process for object detection using safe reinforcement learning according to aspects of the present disclosure.

FIG. 3 shows an example of an object detection scenario according to aspects of the present disclosure.

FIG. 4 shows an example of an object detection apparatus according to aspects of the present disclosure.

FIG. 5 shows an example of a safety system according to aspects of the present disclosure.

FIG. 6 shows an example of a position predication system according to aspects of the present disclosure.

FIG. 7 shows an example of a safety system according to aspects of the present disclosure.

FIG. 8 shows an example of a process for object detection using safe reinforcement learning according to aspects of the present disclosure.

FIG. 9 shows an example of a process for selecting a dynamical safety constraint according to aspects of the present disclosure.

FIG. 10 shows an example of a process for identifying an error according to aspects of the present disclosure.

### DETAILED DESCRIPTION

The present disclosure describes systems and methods for vison based safety systems. Embodiments of the disclosure provide a reinforcement learning model configured to receive state data and determine candidate actions based on the received state data. Embodiments of the disclosure further provide a safety system that updates a dynamical safety constraint based on symbolic state data, as well as filters the actions determined by the reinforcement learning model (e.g., and/or selects an action to be executed) based on the dynamical safety constraint. As a result, the policies can be learned over visual inputs while safety is enforced in the symbolic state space.

Recently, vision based safety systems have used deep reinforcement learning algorithms that are effective at learning, from raw image data, control policies that optimize a quantitative reward signal aligned with safety constraints. Because learning such safety policies may require large (e.g., unrealistic) amounts of training data and may require experiencing of many (e.g., millions) of unsafe actions, such techniques may not be justified for use in safety-critical domains where industry standards demand strong evidence of safety prior to deployment. In some cases, vision based safety systems have used formally constrained reinforcement learning for establishing more rigorous safety constraints. However, such formally constrained reinforcement learning techniques typically enforce constraints over a completely symbolic state space that is assumed to be noiseless (e.g. the position of the safety-relevant objects are extracted from a simulator's internal state).

Embodiments of the present disclosure provide an improved vision based safety system that implements a pre-trained object detection system, that is used during reinforcement learning, to extract the positions of safety-relevant objects (e.g., obstacles, hazards, etc.) in a symbolic state space. As such, candidate actions (e.g., candidate maneuvers in the environment) that are determined by the reinforcement learning model can be filtered based on the positions (e.g., and previous positions) of safety-relevant objects in the symbolic state space in order to enforce formal safety constraints when selecting actions to be executed within the environment.

Embodiments of the present disclosure combine reinforcement learning with machine learning based object detection. Object detection generally refers to tasks such as detecting and/or determining object information such as object features, object shapes, object types, object position information, etc. In some cases, object detection techniques are implemented in autonomous safety systems that are based on visual input. For example, autonomous vehicles may implement object detection techniques in vision based safety systems subject to strict safety constraints (e.g., such that autonomous vehicles safely navigate roadways with respect to pedestrians, other vehicles, environment objects such as street signs and trees, etc.).

By applying the unconventional step of establishing optimality for policies that are learned from a low-level feature space (i.e., images), the techniques described herein may optimize reward for vision based safety system even when aspects of the reward structure are not extracted as high-level features used for safety checking. That is, the techniques described herein may optimize actions selected in the presence of environmental objects whose positions may not necessarily be extracted via supervised training. As such, the vision based safety systems described herein may use pre-trained object detectors that are only trained with safety-relevant objects, which may significantly reduce otherwise unrealistic amounts of required training data, may learn policies over visual inputs while safety is enforced in the symbolic state space, etc. For at least these reasons, embodiments of the present disclosure provide improved vision based safety systems that are efficient and scalable to real world applications.

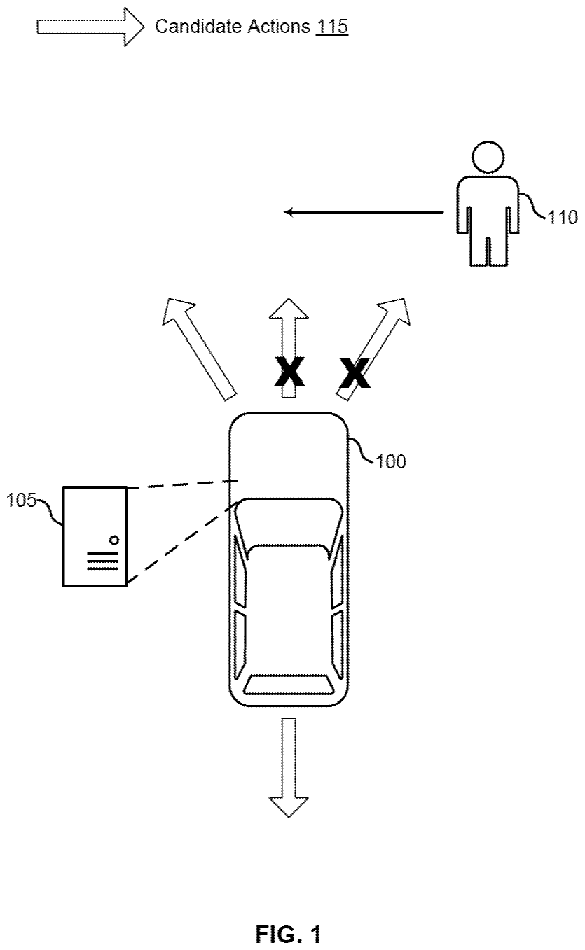

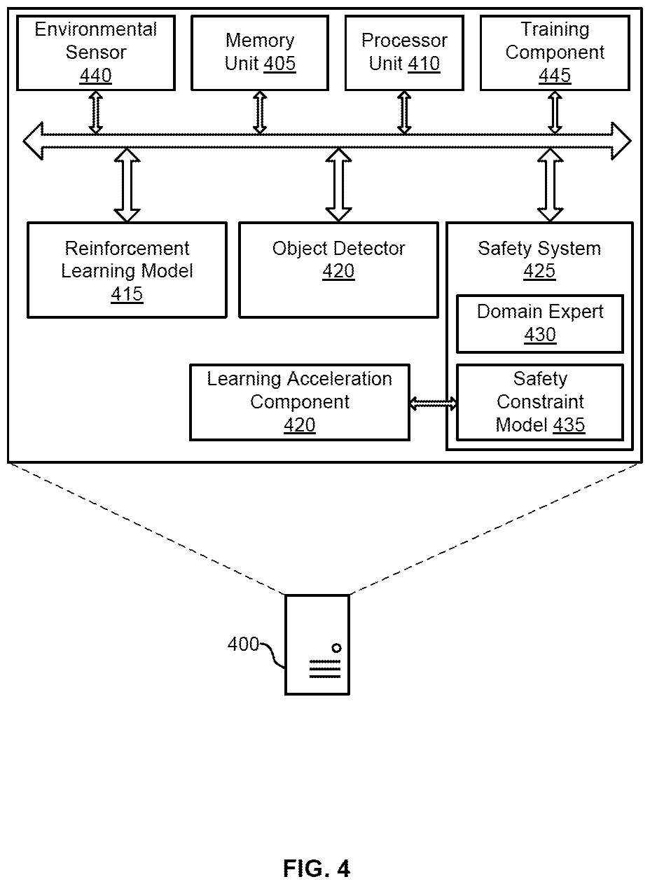

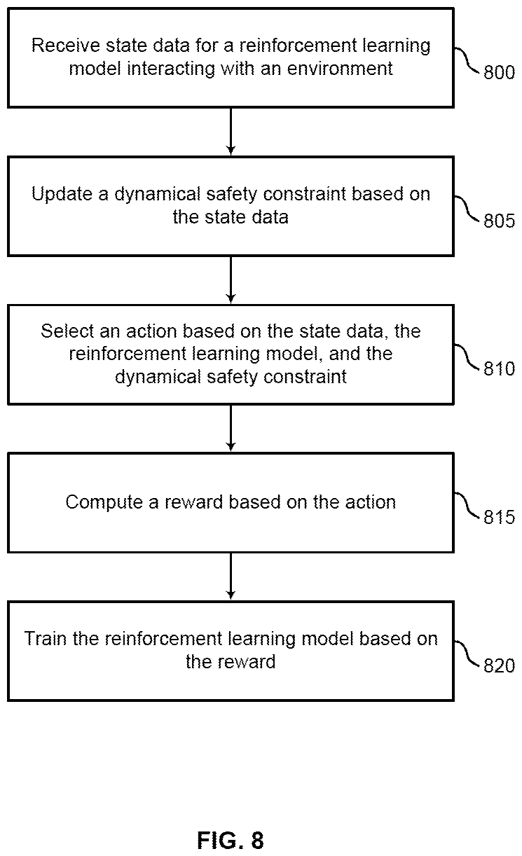

Embodiments of the present disclosure may be used in the context of vision based safety systems. For example, a reinforcement learning model may select candidate actions based on received state data, and a safety system may update a dynamical safety constraint based on symbolic state data received from a pre-trained object detector in order to filter the actions selected by the reinforcement learning model based on the dynamical safety constraint. An example of an application of the inventive concept in the vision based safety context is provided with reference to FIGS. 1 through 3. Details regarding the architecture of an example network are provided with reference to FIGS. 4 through 7. A description of an example training process is described with reference to FIG. 8.

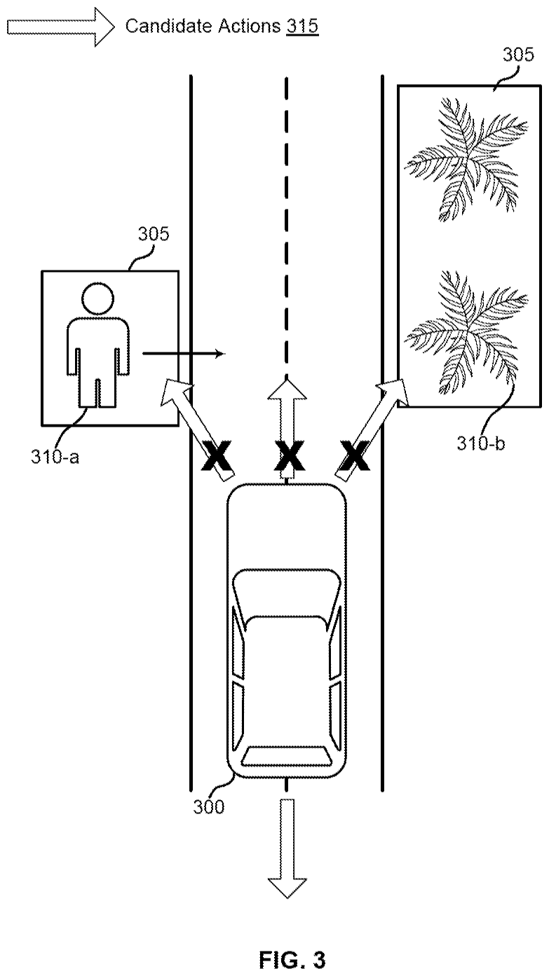

FIG. 1 shows an example of an object detection system according to aspects of the present disclosure. The example shown includes vehicle 100 and object 110. Vehicle 100 is an example of, or includes aspects of, the corresponding element described with reference to FIG. 3. In one embodiment, vehicle 100 includes object detection apparatus 105. Object 110 is an example of, or includes aspects of, the corresponding element described with reference to FIG. 3.

As described herein, object detection techniques can be implemented in autonomous safety systems that are based on visual input. For example, autonomous vehicles (e.g., such as vehicle 100) may implement object detection techniques in vision based safety systems (e.g., via object detection apparatus 105) subject to strict safety constraints. For example, using the techniques described herein, vehicle 100 can navigate an environment (e.g., roadways) safely by adhering to safety constrains, such as avoiding objects 110 (e.g., which generally may include pedestrians, other vehicles, environment objects such as street signs and trees, etc.).

In the example of FIG. 1, a vehicle 100 is depicted as implementing the vison based safety techniques described herein. However, the vison based safety techniques described herein may be implemented in various systems including robotics and manufacturing plants, among any other environment or system using vision based techniques (e.g., such as object detection) for implementation of safety measures.

Vision based safety systems may implement reinforcement learning models to interact with an environment to learn the environment and perform tasks (e.g., actions) within the environment. Such systems subject to safety constraints (e.g., such as systems in autonomous vehicles, in manufacturing plant environments, etc.) may specify and enforce safety constraints in settings with visual inputs by combining object detectors with formally verified safety guards.

For instance, vehicle 100 may include object detection apparatus 105 that may implement aspects of the vison based safety techniques described herein. Object detection apparatus 105 may include a reinforcement learning model configured to receive state data (e.g., image state data) and determine candidate actions 115 (e.g., environment navigation actions, environment modification actions, etc.) based on the received state data. Object detection apparatus 105 may include an object detector configured to generate symbolic state data (e.g., safety relevant data) from the state data. Accordingly, as described herein, object detection apparatus 105 can update a dynamical safety constraint based on the symbolic state data, as well as filter the actions determined by the reinforcement learning model and select an action to be executed based on the dynamical safety constraint.

For instance, the object detection apparatus 105 classifies each action (e.g., each candidate action 115 determined by the reinforcement learning model) in each symbolic state as either “safe” or “not safe” based on the dynamical safety constraint (e.g., and a safe action may be selected and executed to modify or navigate the environment). In the example of FIG. 1, object detection apparatus 105 may detect object 110 (e.g., and possible movement/trajectory of object 110) and may select actions from candidate actions 115 accordingly. For instance, object detection apparatus 105 may determine that steering or accelerating away from the object 110 are safe actions (e.g., to avoid collision with the object 110). In some instance, vehicle 100 may include a tool (e.g., such as a steering wheel, a decelerator, an accelerator, etc.) that is configured to execute the selected actions to modify or navigate the environment (e.g., such as to slow down, brake, steer left away from object 110, accelerate left away from object 110, etc.).

Systems may implement reinforcement learning to interact with an environment and perform tasks. In some cases, settings may require safe training, which may include specifying which system states and which system actions are safe (e.g., where such specifications are typically formal constrains over the state/action space). Some techniques may include specifying and enforcing safety constraints in settings with visual inputs by combining object detectors with formally verified safety guards.

In some cases, computer vision systems perform an object detection task which includes drawing bounding boxes around detected objects. However, these systems occasionally draw bounding boxes incorrectly, causing the safety system (e.g., the agent) to take incorrect actions. One way to address this is to use previous states and known dynamical models for the obstacle as priors on the vision system to reject likely misclassifications. In this approach, misclassifications may be intermittent, and the safety models may entail minimal models of system behavior. However, object classification does not entail a single unique dynamical model. Parameter uncertainty also occurs within known dynamical models.

Accordingly, dynamical priors (i.e., models of object behavior) may be used to detect possible misclassifications. When detected, previous observation and feasible models are used to conservatively approximate the possible state of the system. However, using overly conservative models object behavior restricts the set of available agents for reinforcement learning agent. Therefore, some reinforcement learning models may select actions helping falsify unsuitable candidate models.

There are methods and systems of model-free safe symbolic reinforcement learning performed from dynamic visual inputs. Here, dynamical systems priors are not used to track the location of objects.

Other systems use a model of objects behavior (i.e., a simulator of the environment) and set of safe states. These simulate each action (for instance, use explicit models to check safety). However, the applicability is lost if no model is available. Visual inputs are not used, and work is performed over symbolic states. Vision system classifies multiple relevant objects (and not just those relevant to safety).

Another approach used for safe recurrent learning includes human demonstrated safe actions or supervised training. For instance, approaches including generalizing safety to states the human did not demonstrate on or developing safety on the human's performance may be complex. Object detection and tracking techniques described herein are integrated into a safe reinforcement learning system. For instance, symbolic mappings are used to map visual inputs in a fixed logic.

The techniques described herein do not necessarily use a complete model of the global environment. A model of possible actions and safety-relevant components of a system is included. These are applicable in complex (visual) state spaces which allow domain experts to specify high-level safety constraints. The visual input is then mapped to high-level features to check for constraints. Time to perform safety constraints specified by the domain expert is reduced. The safety rules are interpretable. The perception system uses action models for tracked objects.

For instance, a real-world application may include robots in a robotic warehouse where the robots bring stacks of goods from the warehouse to human packers. The safety constraints (defined separately for multiple robots, human workers and stacks of goods) can control the allowed locations and speeds of robots.

The perception system uses dynamics models together with visual inputs to track the locations of objects, reducing the negative impact of intermittent misclassifications.

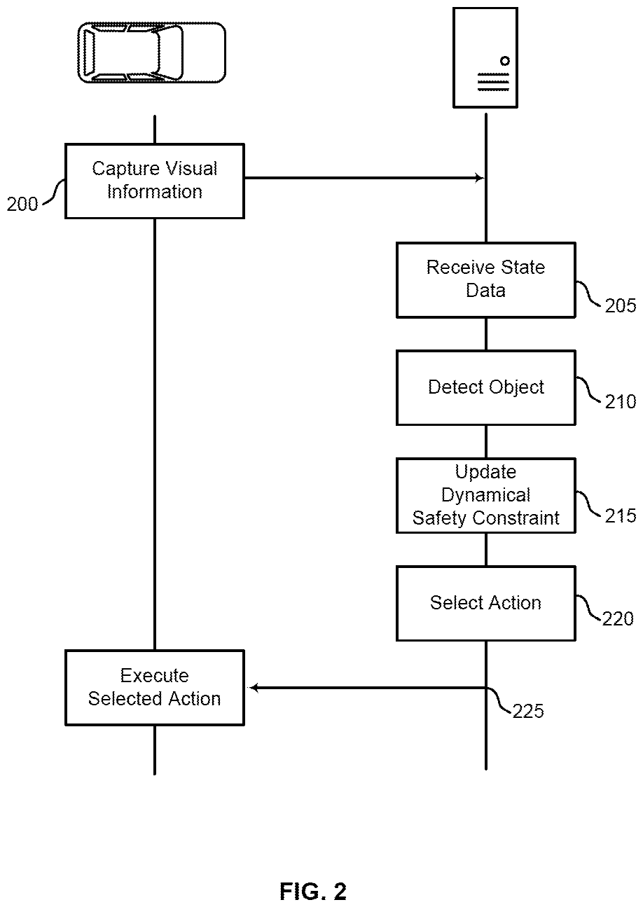

FIG. 2 shows an example of a process for object detection using safe reinforcement learning according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for object detection using safe reinforcement learning is described. Embodiments of the method are configured to receive state data for a reinforcement learning model interacting with an environment and detect an object in the environment based on the state data. Embodiments of the method are further configured to update a dynamical safety constraint corresponding to the object based on the state data and select an action based on the state data, the reinforcement learning model, and the dynamical safety constraint.

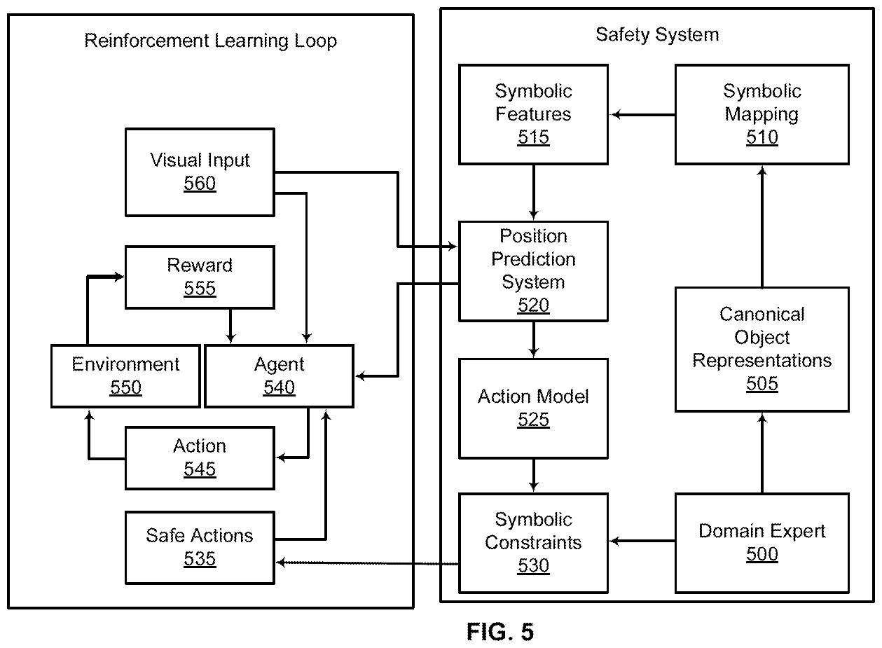

At operation 200, the system captures visual information. In some cases, the operations of this step refer to, or may be performed by, an environmental sensor as described with reference to FIGS. 4 and 5.

At operation 205, the system receives state data for a reinforcement learning model interacting with an environment. In some cases, the operations of this step refer to, or may be performed by, a reinforcement learning model as described with reference to FIG. 4.

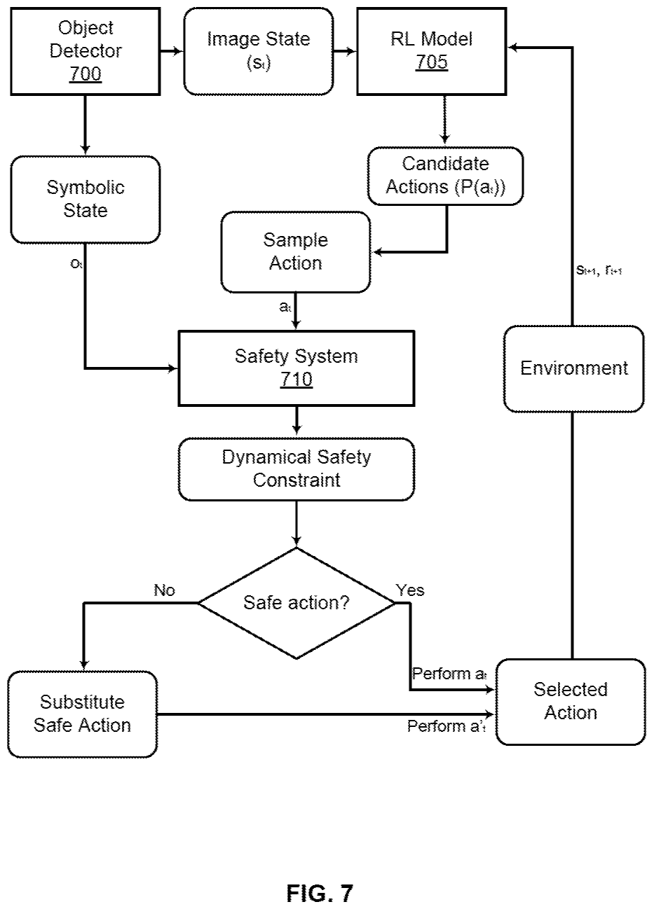

At operation 210, the system detects an object in the environment based on the state data. In some cases, the operations of this step refer to, or may be performed by, an object detector as described with reference to FIGS. 4 and 7.

At operation 215, the system updates a dynamical safety constraint corresponding to the object based on the state data. In some cases, the operations of this step refer to, or may be performed by, a safety system as described with reference to FIGS. 4 and 7.

At operation 220, the system selects an action based on the state data, the reinforcement learning model, and the dynamical safety constraint. In some cases, the operations of this step refer to, or may be performed by, a safety system as described with reference to FIGS. 4 and 7.

At operation 225, the system executes the selected action to modify or navigate the environment. In some cases, the operations of this step refer to, or may be performed by, a tool (e.g., which may be included in a vehicle as described with reference to FIGS. 1 and 3).

An apparatus for object detection using safe reinforcement learning is described. The apparatus includes a processor, memory in electronic communication with the processor, and instructions stored in the memory. The instructions are operable to cause the processor to receive state data for a reinforcement learning model interacting with an environment, detect an object in the environment based on the state data, update a dynamical safety constraint corresponding to the object based on the state data, and select an action based on the state data, the reinforcement learning model, and the dynamical safety constraint.

A non-transitory computer readable medium storing code for object detection using safe reinforcement learning is described. In some examples, the code comprises instructions executable by a processor to: receive state data for a reinforcement learning model interacting with an environment, detect an object in the environment based on the state data, update a dynamical safety constraint corresponding to the object based on the state data, and select an action based on the state data, the reinforcement learning model, and the dynamical safety constraint.

A system for object detection using safe reinforcement learning is described. Embodiments of the system are configured to receive state data for a reinforcement learning model interacting with an environment, detect an object in the environment based on the state data, update a dynamical safety constraint corresponding to the object based on the state data, and select an action based on the state data, the reinforcement learning model, and the dynamical safety constraint.

Some examples of the method, apparatus, non-transitory computer readable medium, and system described above further include generating symbolic state data based on the state data, wherein the symbolic state data includes the detected object. Some examples of the method, apparatus, non-transitory computer readable medium, and system described above further include identifying a current location of the object on the state data. Some examples further include identifying a previous location of the object based on the state data, wherein the dynamical safety constraint is updated based on the current location and the previous location.

In some examples, the dynamical safety constraint is based on a safety constraint model representing motion of the object. Some examples of the method, apparatus, non-transitory computer readable medium, and system described above further include determining the dynamical safety constraint based on at least one of a plurality of safety constraint models associated with the object.

Some examples of the method, apparatus, non-transitory computer readable medium, and system described above further include determining that the state data is inconsistent with a first safety constraint model. Some examples further include selecting a second safety constraint model for the dynamical safety constraint based on the determination. Some examples of the method, apparatus, non-transitory computer readable medium, and system described above further include determining that the state data is inconsistent with each of a plurality of candidate safety constraint models. Some examples further include identifying an error in detecting the object based on the determination.

Some examples of the method, apparatus, non-transitory computer readable medium, and system described above further include receiving a plurality of candidate actions from the reinforcement learning model. Some examples further include eliminating an unsafe action from the plurality of candidate actions based on the dynamical safety constraint, wherein the action is selected from the plurality of candidate actions after eliminating the unsafe action.

Some examples of the method, apparatus, non-transitory computer readable medium, and system described above further include determining that taking the action will result in improvement in updating the dynamical safety constraint, wherein the action is selected based on the determination. Some examples of the method, apparatus, non-transitory computer readable medium, and system described above further include computing a reward for the reinforcement learning model based on the state data. Some examples further include training the reinforcement learning model based on the reward.

FIG. 3 shows an example of an object 310 detection scenario according to aspects of the present disclosure. The example shown includes vehicle 300 and bounding box 305. Vehicle 300 is an example of, or includes aspects of, the corresponding element described with reference to FIG. 1. In one embodiment, bounding box 305 includes object 310. Object 310 is an example of, or includes aspects of, the corresponding element described with reference to FIG. 1.

As described herein, object detection techniques can be implemented in autonomous safety systems that are based on visual input. For example, autonomous vehicles (e.g., such as vehicle 300) may implement object detection techniques in vision based safety systems (e.g., via an object detection apparatus) subject to strict safety constraints. For example, using the techniques described herein, vehicle 300 can navigate an environment (e.g., roadways) safely by adhering to safety constrains, such as avoiding objects 310 (e.g., which generally may include pedestrians, other vehicles, environment objects such as street signs and trees, etc.).

In the example of FIG. 3, a vehicle 300 is depicted as implementing the vison based safety techniques described herein. However, the vison based safety techniques described herein may be implemented in various systems including robotics and manufacturing plants, among any other environment or system using vision based techniques (e.g., such as object detection) for implementation of safety measures.

Vehicle 300 may implement aspects of the vison based safety techniques described herein. Vehicle 300 (e.g., an object detection apparatus of vehicle 300) may include a reinforcement learning model configured to receive state data (e.g., image state data) and determine candidate actions 315 (e.g., environment navigation actions, environment modification actions, etc.) based on the received state data. Vehicle 300 (e.g., an object detection apparatus of vehicle 300) may include an object detector configured to generate symbolic state data (e.g., safety relevant data) from the state data. Accordingly, as described herein, vehicle 300 (e.g., an object detection apparatus of vehicle 300) can update a dynamical safety constraint based on the symbolic state data, as well as filter the actions determined by the reinforcement learning model and select an action to be executed based on the dynamical safety constraint.

For instance, vehicle 300 (e.g., an object detection apparatus of vehicle 300) classifies each action (e.g., each candidate action 315 determined by the reinforcement learning model) in each symbolic state as either “safe” or “not safe” based on the dynamical safety constraint (e.g., and a safe action may be selected and executed to modify or navigate the environment). In the example of FIG. 3, vehicle 300 (e.g., an object detection apparatus of vehicle 300) may detect objects 310 (e.g., and possible movement/trajectory of any objects 310) and may select actions from candidate actions 315 accordingly.

For instance, vehicle 300 (e.g., an object detection apparatus of vehicle 300) may determine that steering or accelerating away from a first object 310-a are safe actions (e.g., to avoid collision with the object 310-a). However, vehicle 300 (e.g., an object detection apparatus of vehicle 300) may determine that steering away from first object 310-a may result in collision with a second object 310-b. Therefore, in the example of FIG. 3, vehicle 300 (e.g., an object detection apparatus of vehicle 300) may select an action of deceleration to safely avoid objects 310-a and 310-b. In some instance, vehicle 300 may include a tool (e.g., such as a steering wheel, a decelerator, an accelerator, etc.) that is configured to execute the selected actions to modify or navigate the environment (e.g., such as to slow down, brake, etc.).

As described herein, deep reinforcement learning in safety-critical settings use algorithms to obey hard constraints during exploration. Embodiments of the present disclosure provide for enforcing of formal safety constraints on end-to-end policies with visual inputs. The present disclosure provides safe learning that for reward signals that may not align with safety constraints, avoids unsafe behavior, and optimizes to improve safety. Additionally, enforces the safety constraints to preserve the safe policies from the original environment.

Deep reinforcement learning algorithms are effective at learning from sensor inputs and control policies optimizing for a quantitative reward signal. However, unsafe actions are experienced as a result of learning these policies. Some methods (i.e., where reward signal reflects relevant safety priorities) use an unrealistic amount of training data to justify the role of reinforcement learning (RL). Strong evidence of safety prior to deployment is used to implement reinforcement learning algorithms in certain domains.

Formal verification provides a rigorous way of establishing safety for traditional control. The difficulty of providing formal guarantees in reinforcement learning is called formally constrained reinforcement learning (hereinafter, FCRL). FCRL methods are commonly used to optimize for a reward function while safely exploring the environment. However, contemporary FCRL methods enforce constraints over a symbolic state-space assumed to be noiseless (i.e., positions of safety-relevant objects are extracted from a simulator's internal state). The entire reward structure is assumed to depend on the same symbolic state-space used to enforce formal constraints. A symbolic representation of the reward structure uses more labeled data. Real-world application of FCRL is limited where a system's state is inferred by imperfect and untrusted perception systems. Furthermore, the present disclosure cannot generalize across environments with different reward structures and similar safety concerns.

The present study learns a safe policy without assuming a perfect oracle to identify the positions of safety-relevant objects (i.e., independent of the internal state of a simulator). Prior to reinforcement learning, a detection system is trained to extract positions of safety-relevant objects to enforce formal safety constraints. Absolute safety in the presence of unreliable perception is challenging, but formal safety constraints account for a type of noise found in object detection systems. Finally, verifiably safe reinforcement learning techniques use fewer labeled data to pre-train object detection. An end-to-end policy thus obtained leverages the entire visual observation for reward optimization.

Prior work demonstrates the use of safe reinforcement learning in observation of the entire state and symbolic characterization of the environment. However, robotic systems cannot interact with a physical world and perceive the physical world through an imperfect visual system. Highly robust behavior is achieved by leveraging techniques such as the use of contemporary vision techniques to connect visual input and symbolic representation. The present disclosure safely converges to a safe policy under weak assumptions from a vision system.

Presently used FCRL algorithms provide convergence guarantees for an environment (for instance, Markov Decision Process (MDP)) defined over high-level symbolic features extracted from the internal state of a simulator. However, the convergence result for FCRL in the present study establishes policies learned from low-level feature spaces (i.e., images). For instance, the method optimizes reward when significant aspects of a reward structure are not extracted as high-level features for safety checking. Verifiably safe reinforcement learning techniques optimize reward structures related to objects whose positions are not extracted using supervised training. Therefore, the present disclosure uses pre-trained object detectors for safety-relevant objects.

A safe exploration in reinforcement learning is provided, which includes both environments where the reward signal is aligned with safety goals and where a reward-optimal policy is unsafe. In environments where reward-optimal policy is safe (“reward-aligned”), the verifiably safe reinforcement learning techniques learn a safe policy with convergence rates and final rewards. In environments where reward-optimal policy is unsafe, verifiably safe reinforcement learning techniques optimize subsets of rewards without violating safety constraints and successfully avoids reward-hacking by violating safety constraints.

The present disclosure does not make unrealistic assumptions about oracle access to symbolic features and uses minimal supervision before reinforcement learning begins to safely explore, while optimizing for a reward. Verifiably safe reinforcement learning techniques learn safely and maintain convergence properties of underlying deep reinforcement learning algorithms within a set of safe policies.

A reinforcement learning system (for instance, MDP) includes sets of system states, action spaces and transition functions. These specify probabilities for another system state after a safety system (e.g., an agent) executes actions, states and reward functions to give reward for actions and discount factors indicating system preferences to earn faster rewards.

In a setting, images and safety specifications over a set of high-level observations are given, such as the positions (i.e., planar coordinates) of safety-relevant objects in a 2D or 3D space. However, pre-training a system to convert visual inputs into symbolic states using synthetic data (without acting in an environment) provides for learning a safe policy along multiple trajectories. Policies are learned over a visual input space while enforcing safety in symbolic state spaces.

Initial states are assumed safe and each state reached has a minimum of one available safe action. Accuracy of discrete-time dynamical models of safety-relevant dynamics in the environment and precision of abstract models of safety system behavior describing safe controller behaviors at high-level (disregarding fine-grained details) is assumed. In some cases, a controller may be referred to herein as a safety system. Symbolic mapping of objects (with known upper bound on the number) is done from images through an object detector to maximize Euclidean distance between actual and extracted positions. For instance, a model operating on a symbolic state space may be a system of Ordinary Differential Equations (ODEs) describing the effect of few parameters on future positions of a robot and potential dynamical behavior of hazards in the environment. Therefore, a robot stops if the robot is determined to be too close to a hazard and has any other type of behavior otherwise. Models use safety-related aspects, not reward optimization, and are reasonable to satisfy for practical systems.

The goal of an reinforcement learning agent represented as an MDP (S, A, T, R, γ) is to find a policy π that maximizes an expected total reward from an initial state s₀∈Sᵢₙᵢₜ:

V^{π}(s) [symbol] [symbol] _{π}[Σᵢ₌₀^{∞}(γⁱrᵢ)] (1)

where rᵢ is a reward at step i. DNN parameters θ may be used to parametrize π(a|s; θ). For instance, sample efficiency and stability are increased in proximal policy optimization (PPO) to prevent large policy updates enabling end-to-end learning and reduces dependency of learning tasks on refined domain knowledge. Deep reinforcement learning processes augment certain features, such as time-consumption processes.

Discrete-time (e.g., robots deciding actions at discrete times) and continuous-time dynamics (e.g. ODEs describing positions of robots at any time) of dynamical systems are combined to ensure formal guarantees using differential Dynamic Logic (d [symbol] ). Hybrid programs (HPs) are able to represent a non-deterministic choice between two programs α∪β, and a continuous evolution of a system of ODEs for an arbitrary amount of time, given a domain constraint F on the state space {x′₁=θ₁, . . . , x′ₙ=θₙ & F}.

Formulas of d [symbol] are generated by the following grammar where α ranges over HPs:

φ,ψ::=f˜g|φ∧ψ|φ∨ψ|φ→ψ|∀x·φ|∃x·φ|[α]φ (2)

where f, g are polynomials over state variables, φ and ψ are state variables. [α]φ means a formula φ is true in states reached by executing the hybrid program α.

Given a set of initial conditions init for the initial states, a discrete-time controller ctrl representing the abstract behaviour of the agent, a continuous-time system of ODEs plant representing the environment and a safety property safe defines safety preservation as verifying that Equation (3) holds:

init→[{ctrl; plant}*]safe (3)

Equation (3) means that if the system starts in an initial state that satisfies init, takes one of the (possibly infinite) set of control choices described by ctrl, and then follows the system of ordinary differential equations described by plant, then the system remains in states where safe is true.

Example 1 (Hello, World). Consider a 1D point-mass x avoiding collision with a static obstacle (o) and has perception error bounded by

$$\frac{ϵ}{2} .$$

The following d [symbol] model characterizes infinite set safe controllers, such that x≠o for forward times and at multiple points throughout the entire flow of the ODE:

init→[{ctrl; t:=0; plant}*]x−o>ϵ (4)

where,

SB(a)≡2B(x−o−ϵ)>v²+(a+B)*(aT²+2Tv)) (5)

init≡SB(−B)∧B>0∧T>0A>0∧v≥0∧ϵ>0 (6)

ctrl≡a:=*; ?−B≤a≤A∧SB(a) (7)

plant≡{x′=v, v′=a, t′=1&t≤T∧v≥0} (8)

Starting from any state that satisfies the formula init, the (abstract/non-deterministic) controller chooses an acceleration satisfying the SB constraint. After choosing any a that satisfies SB, the system then follows the flow of the system of ODEs in plant for any positive amount of time t less than T. The constraint v≥0 means braking (i.e., choosing a negative acceleration) can bring the pointmass to a stop, but cannot cause the pointmass to move backward.

The full formula says that no matter how many times the controller is executed and then follows the flow of the ODEs, for an infinite set of permissible controllers, x−o<∈ will be used.

Some methods use synthesis of action space guards from non-deterministic specifications of controllers and explains incorporation of space guards into reinforcement learning to ensure safe exploration. Theorems of d [symbol] are proven using theorem provers.

FIG. 4 shows an example of an object detection apparatus 400 according to aspects of the present disclosure. In one embodiment, apparatus 400 includes memory unit 405, processor unit 410, reinforcement learning model 415, object detector 420, safety system 425, environmental sensor 440, training component 445, and learning acceleration component 450.

An apparatus for object detection using safe reinforcement learning is described. Embodiments of the apparatus include a reinforcement learning model 415 configured to receive state data and to select one or more actions based on the state data, an object detector 420 configured to generate symbolic state data based on the state data, the symbolic state data including an object, and a safety system 425 configured to update a dynamical safety constraint based on the symbolic state data and to filter the actions based on the dynamical safety constraint.

Examples of memory unit 405 include random access memory (RAM), read-only memory (ROM), or a hard disk. Examples of memory devices include solid state memory and a hard disk drive. In some examples, memory unit 405 is used to store computer-readable, computer-executable software including instructions that, when executed, cause a processor to perform various functions described herein. In some cases, the memory unit 405 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

A processor unit 410 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 410 is configured to operate a memory array using a memory controller. In other cases, a memory controller is integrated into the processor. In some cases, the processor unit 410 is configured to execute computer-readable instructions stored in a memory to perform various functions. In some embodiments, a processor unit 410 includes special purpose components for modem processing, baseband processing, digital signal processing, or transmission processing.

In some examples, reinforcement learning model 415 may be, or may include aspects of, an artificial neural network. An artificial neural network is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.”

According to some embodiments, reinforcement learning model 415 receives state data for a reinforcement learning model 415 interacting with an environment. According to some embodiments, reinforcement learning model 415 may be configured to receive state data and to select one or more actions based on the state data.

According to some embodiments, object detector 420 detects an object in the environment based on the state data. In some examples, object detector 420 generates symbolic state data based on the state data, where the symbolic state data includes the detected object. In some examples, object detector 420 identifies a current location of the object on the state data. In some examples, object detector 420 identifies a previous location of the object based on the state data, where the dynamical safety constraint is updated based on the current location and the previous location.

According to some embodiments, object detector 420 may be configured to generate symbolic state data based on the state data, the symbolic state data including an object. According to some embodiments, object detector 420 detects an object based on the state data. In some examples, object detector 420 detects an object based on the state data. Object detector 420 is an example of, or includes aspects of, the corresponding element described with reference to FIG. 7.

According to some embodiments, safety system 425 updates a dynamical safety constraint corresponding to the object based on the state data. In some examples, safety system 425 selects an action based on the state data, the reinforcement learning model 415, and the dynamical safety constraint. In some examples, the dynamical safety constraint is based on a safety constraint model 435 representing motion of the object. In some examples, safety system 425 determines the dynamical safety constraint based on at least one of a set of safety constraint models 435 associated with the object. In some examples, safety system 425 determines that the state data is inconsistent with a first safety constraint model 435. In some examples, safety system 425 selects a second safety constraint model 435 for the dynamical safety constraint based on the determination. In some examples, safety system 425 determines that the state data is inconsistent with each of a set of candidate safety constraint models 435. In some examples, safety system 425 identifies an error in detecting the object based on the determination. In some examples, safety system 425 receives a set of candidate actions from the reinforcement learning model 415. In some examples, safety system 425 eliminates an unsafe action from the set of candidate actions based on the dynamical safety constraint, where the action is selected from the set of candidate actions after eliminating the unsafe action. In some examples, safety system 425 determines that taking the action will result in improvement in updating the dynamical safety constraint, where the action is selected based on the determination.

According to some embodiments, safety system 425 may be configured to update a dynamical safety constraint based on the symbolic state data and to filter the actions based on the dynamical safety constraint. In some examples, the safety system 425 includes a domain expert 430 configured to identify a set of object types and a set of safety constraint models 435 associated with each of the object types. According to some embodiments, safety system 425 selects the dynamical safety constraint from a set of safety constraint models 435 based on the detected object. In some examples, safety system 425 identifies an error in detecting the object based on a set of safety constraint models 435. Safety system 425 is an example of, or includes aspects of, the corresponding element described with reference to FIG. 7. In one embodiment, safety system 425 includes domain expert 430 and safety constraint model 435.

Domain expert 430 is an example of, or includes aspects of, the corresponding element described with reference to FIG. 5.

According to some embodiments, environmental sensor 440 may be configured to monitor an environment and collect the state data. Environmental sensor 440 is an example of, or includes aspects of, the corresponding element described with reference to FIG. 5. In some cases, an environmental sensor 440 may include image sensor (e.g., such as an optical instrument, a video sensor, a camera, etc.) that records or captures images using one or more photosensitive elements that are tuned for sensitivity to a visible spectrum of electromagnetic radiation. Environmental sensor 440 may generally include any sensor capable of measuring the environment, such as a microphone, image sensor, thermometer, pressure sensor, humidity sensor, etc.

According to some embodiments, training component 445 computes a reward for the reinforcement learning model 415 based on the state data. In some examples, training component 445 trains the reinforcement learning model 415 based on the reward. According to some embodiments, training component 445 receives state data for a reinforcement learning model 415 interacting with an environment. In some examples, training component 445 updates a dynamical safety constraint based on the state data. In some examples, training component 445 selects an action based on the state data, the reinforcement learning model 415, and the dynamical safety constraint. In some examples, training component 445 computes a reward based on the action. In some examples, training component 445 trains the reinforcement learning model 415 based on the reward. In some examples, training component 445 selects a subsequent action based on accelerating learning of the dynamical safety constraint. In some examples, training component 445 refrains from updating the reinforcement learning model 415 based on the subsequent action.

According to some embodiments, learning acceleration component 450 may be configured to select an action that can falsify a safety constraint model 435.

A system for object detection using safe reinforcement learning, the system further comprising: a reinforcement learning model configured to receive state data and to select one or more actions based on the state data, an object detector configured to generate symbolic state data based on the state data, the symbolic state data including an object, and a safety system configured to update a dynamical safety constraint based on the symbolic state data and to filter the actions based on the dynamical safety constraint.

A method of manufacturing an apparatus for object detection using safe reinforcement learning is described. The method includes a reinforcement learning model configured to receive state data and to select one or more actions based on the state data, an object detector configured to generate symbolic state data based on the state data, the symbolic state data including an object, and a safety system configured to update a dynamical safety constraint based on the symbolic state data and to filter the actions based on the dynamical safety constraint.

A method of using an apparatus for object detection using safe reinforcement learning is described. The method uses a reinforcement learning model configured to receive state data and to select one or more actions based on the state data, an object detector configured to generate symbolic state data based on the state data, the symbolic state data including an object, and a safety system configured to update a dynamical safety constraint based on the symbolic state data and to filter the actions based on the dynamical safety constraint.

Some examples of the apparatus, system, and method described above further include an environmental sensor configured to monitor an environment and collect the state data. Some examples of the apparatus, system, and method described above further include a tool configured to execute the actions to modify or navigate the environment.

In some examples, the safety system comprises a domain expert configured to identify a set of object types and a set of safety constraint models associated with each of the object types. Some examples of the apparatus, system, and method described above further include a learning acceleration component configured to select an action that can falsify a safety constraint model.

FIG. 5 shows an example of a safety system according to aspects of the present disclosure. The example shown includes domain expert 500, canonical object representations 505, symbolic mapping 510, symbolic features 515, position prediction system 520, action model 525, symbolic constraints 530, safe actions 535, agent 540, action 545, environment 550, reward 555, and visual input 560. Domain expert 500 is an example of, or includes aspects of, the corresponding element described with reference to FIG. 4.

The computer vision/reinforcement learning agent 540 uses high-level (symbolic) safety constraints 530 from a domain expert 500, canonical object representations 505, and visual input 560 from the reinforcement-learning environment as input. The action model 525 used for each tracked object is different from the MDP model referred to as model-free vs. model-based. The visual input 560 is mapped to symbolic features 515 which leverages action model 525 for tracked objects followed by a symbolic constraint 530 checking leading to an execute action 545 in the environment 550. The learning agent 540 gives a set of safe actions 535 in the present state and a safe control policy as the output.

An environmental sensor may take sets of lookahead simulators corresponding to each possible dynamics model and threshold value (>0) as input. The model predicts the course of action as the output. For instance, a candidate whose random action and a set of parameters are determined with some models (≥1) such that:

|m_i(f(x, θ)−y)|>ε (9)

where x and y are the observed actions and resulting state offsets. Equation (9) can be encoded as a SAT query in first-order real arithmetic. If the formula mentioned above is SAT, set candidate to satisfying x and return candidate. Furthermore, predicted position of an object is integrated with the safety constraints 530, optimizing/maximizing the overall reward 555 while remaining safe.

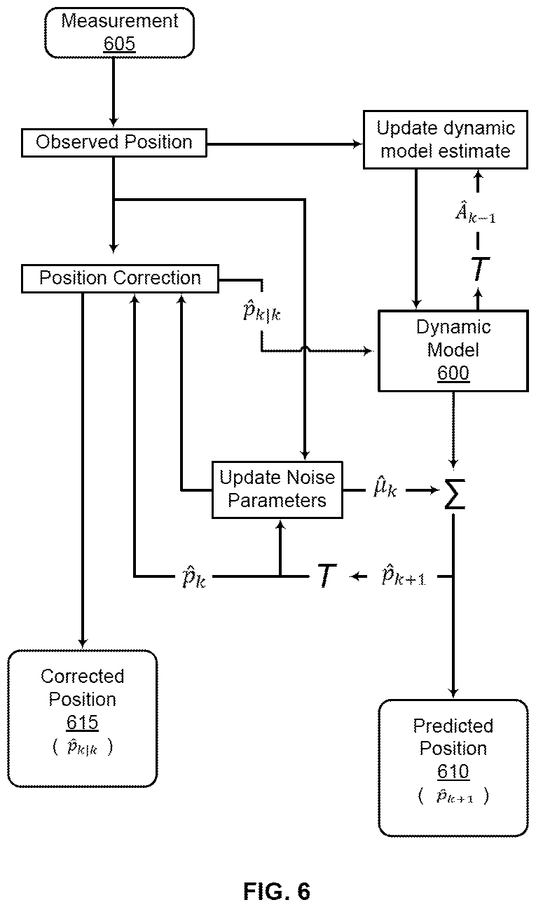

FIG. 6 shows an example of a position predication system according to aspects of the present disclosure. The example shown includes dynamic model 600, measurement 605, predicted position 610, and corrected position 615.

The example position predication system of FIG. 6 may illustrate implementation of a dynamic model 600 to correct position information (e.g., determine corrected position 615) that is predicted based on a measurement 605. The corrected position 615, learnt in real-time without any additional information, increases the overall performance of the system. Furthermore, predicted position 610 of object is integrated with the safety constraints optimizing/maximizing the overall reward while remaining safe.

The following equations represent an object's position using discrete-time linear dynamical system and observation model:

pₖ₊₁=A₀pₖ+A₁pₖ₋₁+A₂pₖ₋₂+δₖ (10)

qₖ=pₖ+θₖ (11)

where,

pₖ=[xₖ yₖ]^{T}; xₖ=object·x,yₖ=object·y (12)

{pₖ, qₖ, δₖ, θₖ}∈Z², {A₀, A₁, A₂,}∈Z^{2×2}

δₖ˜ [symbol] (μ, Δ), θₖ˜ [symbol] (ν, Θ); {μ, ν}∈Z², {Δ, Θ}∈Z^{2×2}

where pₖ is the true position of an obstacle (e.g., an obstacle as described with reference to FIGS. 1 and 3), qₖ is observed position as returned by the template matching algorithm, corrupted by measurement noise θₖ.

The enforce system matrices (A₀, A₁, A₂), system noise (δₖ) and observation noise (θₖ) take integer values, resulting in integer values for the state (pₖ) and observation (qₖ) vectors. The state and observation vectors represent the pixel positions which are integers. Some methods suggest system noise (δₖ) and observation noise (θₖ) follow discrete multivariate Gaussian distributions, where both the mean vectors (μ, ν) and covariance matrices (Δ, Θ) are integers. Parameters of the observation model (A₀, A₁, A₂, μ, Δ) are not known apriori and the dynamical system is learnt in real-time. Latent forces driving the system and quantization error of the dynamics model are accounted for in the system noise. The difference equation with lag 2 takes into consideration the effect of velocity & acceleration on position. In general the underlying system is not restricted to lag 2, it can have any lag <k.

Techniques described herein provide simultaneous learning of model parameters and correction and prediction of object position. The estimates of the model parameters at the k^{th} time-index is represented by \hat{.}ₖ and the corrected and predicted object positions are represented by \hat{p}_{k|k} and \hat{p}ₖ₊₁, respectively.

Initialize:

$${\hat{p}}_{0} = {q}_{0} = [ \begin{matrix}object \cdot x \\ object \cdot y\end{matrix} ] ; \{ {\hat{A}}_{0 , - 1} , {\hat{A}}_{1 , - 1} , {\hat{A}}_{2 , - 1} \} = {1}_{2 \times 2} ; \\ \{ {\hat{μ}}_{0} , {\hat{v}}_{0} \} = {0}_{2} ; \{ {\hat{Δ}}_{0} , {\hat{Θ}}_{0} \} = {I}_{2 \times 2}$$

For k≥0:

{Â_{0,k}, Â_{1,k}, Â_{2,k}}←g([qⱼ]ⱼ₌₀^{k}, [Â_{0,j}, Â_{1,j}, Â_{2,j}]ⱼ₌₀^{k-1})

{\hat{μ}ₖ, \hat{ν}ₖ, \hat{Δ}ₖ, Θₖ}←Fit residuals to discrete Gaussian

Ωₖ={Â_{0,k}, Â_{1,k}, Â_{2,k}, \hat{μ}ₖ, \hat{ν}ₖ, \hat{Δ}ₖ, \hat{Θ}ₖ}

\hat{p}_{k|k}←f(\hat{p}ₖ, \hat{q}ₖ, Ωₖ)

\hat{p}ₖ₊₁=Â_{0,k}\hat{p}_{k|k}+Â_{0,k-1}\hat{p}_{k-1|k+1}+Â_{0,k-2}\hat{p}_{k-2|k-2}+\hat{μ}ₖ (13)

FIG. 7 shows an example of a safety system 710 according to aspects of the present disclosure. The example shown includes object detector 700, reinforcement learning (RL) model 705, and safety system 710. Object detector 700 is an example of, or includes aspects of, the corresponding element described with reference to FIG. 4. Safety system 710 is an example of, or includes aspects of, the corresponding element described with reference to FIG. 4.

Verifiably safe reinforcement learning techniques provide a framework to augment deep reinforcement learning algorithms to perform safe exploration on visual inputs is presented. Embodiments of the present disclosure learn mapping of visual inputs into symbolic states for safety-relevant properties using a few examples and learn policies over visual inputs, while enforcing safety in the symbolic state. A safety system 710 (e.g., a controller monitor) may include a function φ:O×A→{0,1} that classifies each action a in each symbolic state o as safe or not safe. The present disclosure provides a synthesis of safety systems 710 by using safety preservation for high-level reward-agnostic safety properties characterizing subsets of environmental dynamics plant, a description of safe controllers, and initial conditions.

As described herein, a computer vision/reinforcement learning model 705 uses high-level (symbolic) safety constraints from a domain expert, canonical object representations, and visual input (e.g., image state sₜ) from the reinforcement-learning environment as input. An image state sₜ is mapped to a symbolic state. The reinforcement learning model 705 gives a set of actions P(aₜ) in the present state. The safety system 710 then receives the symbolic constraints oₜ as well as the action aₜ selected by the reinforcement learning model 705 to update a dynamical safety constraint based on the symbolic state data and to filter the actions based on the dynamical safety constraint. For instance, safety system 700 may access whether aₜ is a safe action, or whether a substitute action a′ₜ is to be performed (e.g., the safety system may filter actions P(aₜ) to execute action that are safe based on the symbolic constraints oₜ).

To avoid constructing labelled datasets for each environment, small sets of images of each safety-critical object and background images (i.e., 1 image per object and 1 background) are assumed to be provided. Synthetic images are generated by pasting objects onto backgrounds with different locations, rotations, and other augmentations. An object detector 700 (e.g., a CenterNet-style object detector 700) is then trained to perform multi-way classification to check if each pixel is the center of an object. Feature extraction convolutional neural network (CNN) is truncated to keep the first residual block to increase speed and visual simplicity of the environments. A modified focal loss is called loss function. The present disclosure does not optimize or dedicate hardware to the object detector 700, which may increase run-time overhead for environments.

A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Embodiments of the present disclosure augment deep reinforcement learning algorithms to proximal policy optimization (PPO). For example, algorithms perform reinforcement learning except when an action is attempted. Object detectors 700 and safety monitors (e.g., safety system 710) first check safety of the action. If the action is determined to be unsafe, a safe action is sampled at random outside of the agent from safe actions in a present state to wrap the environment with a safety check.

Pseudocode for performing the wrapping is in Algorithm 1. The safety system 710 is extracted from a verified d [symbol] model with a full code listing which in-lines Algorithm 1 into a reinforcement learning algorithm.

Algorithm 1 The verifiably safe reinforcement
learning technique safety guard

Input: sₜ: input image; aₜ: input action; ψ: object detector; φ: safety system;
E = ( [symbol] , [symbol] , R, T): MDP of the original environment
aₜ′ = aₜ
if - φ(ψ(sₜ), aₜ) then
Sample substitute safe action aₜ′ uniformly from {a ∈ [symbol] |φ(ψ(sₜ), a)}
Return sₜ₊₁~T(sₜ, aₜ′,), rₜ₊₁~R(sₜ, aₜ′)

Verifiably safe reinforcement learning techniques may choose safe actions, and if a verifiably safe reinforcement learning technique is used with an reinforcement learning system that converges, then the verifiably safe reinforcement learning technique converges to a safe policy.

If conditions hold along a trajectory for a model of an environment and a model of the controller (e.g., the safety system 700), where each input action is chosen based on Algorithm 1, then states along the trajectory are safe. The results imply Algorithm 1 augmented reinforcement learning agents are safe during learning. It can also be shown that any reinforcement learning agent which learns a policy in an environment can be combined with Algorithm 1 to learn a reward-optimal safe policy.

If E is an environment, L is a reinforcement learning algorithm and converges to reward-optimal policy using Algorithm 1 with L converging the safe policy with the highest reward (i.e., the reward-optimal safe policy).

FIG. 8 shows an example of a process for object detection using safe reinforcement learning according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for training a neural network is described. Embodiments of the method are configured to receiving state data for a reinforcement learning model interacting with an environment, updating a dynamical safety constraint based on the state data, selecting an action based on the state data, the reinforcement learning model, and the dynamical safety constraint, computing a reward based on the action, and training the reinforcement learning model based on the reward.

At operation 800, the system receives state data for a reinforcement learning model interacting with an environment. In some cases, the operations of this step refer to, or may be performed by, a training component as described with reference to FIG. 4.

At operation 805, the system updates a dynamical safety constraint based on the state data. In some cases, the operations of this step refer to, or may be performed by, a training component as described with reference to FIG. 4.

At operation 810, the system selects an action based on the state data, the reinforcement learning model, and the dynamical safety constraint. In some cases, the operations of this step refer to, or may be performed by, a training component as described with reference to FIG. 4.

At operation 815, the system computes a reward based on the action. In some cases, the operations of this step refer to, or may be performed by, a training component as described with reference to FIG. 4.

At operation 820, the system trains the reinforcement learning model based on the reward. In some cases, the operations of this step refer to, or may be performed by, a training component as described with reference to FIG. 4.

An apparatus for object detection using safe reinforcement learning is described. The apparatus includes a processor, memory in electronic communication with the processor, and instructions stored in the memory. The instructions are operable to cause the processor to receive state data for a reinforcement learning model interacting with an environment, update a dynamical safety constraint based on the state data, select an action based on the state data, the reinforcement learning model, and the dynamical safety constraint, compute a reward based on the action, and train the reinforcement learning model based on the reward.

A non-transitory computer readable medium storing code for object detection using safe reinforcement learning is described. In some examples, the code comprises instructions executable by a processor to: receive state data for a reinforcement learning model interacting with an environment, update a dynamical safety constraint based on the state data, select an action based on the state data, the reinforcement learning model, and the dynamical safety constraint, compute a reward based on the action, and train the reinforcement learning model based on the reward.

A system for object detection using safe reinforcement learning is described. Embodiments of the system are configured to receiving state data for a reinforcement learning model interacting with an environment, updating a dynamical safety constraint based on the state data, selecting an action based on the state data, the reinforcement learning model, and the dynamical safety constraint, computing a reward based on the action, and training the reinforcement learning model based on the reward.

Some examples of the method, apparatus, non-transitory computer readable medium, and system described above further include selecting a subsequent action based on accelerating learning of the dynamical safety constraint.

Some examples of the method, apparatus, non-transitory computer readable medium, and system described above further include refraining from updating the reinforcement learning model based on the subsequent action.

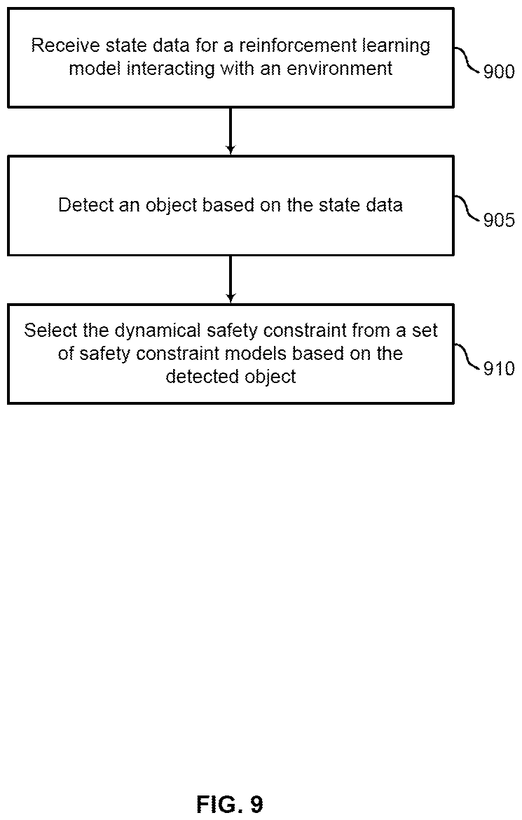

FIG. 9 shows an example of a process for selecting a dynamical safety constraint according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Some examples of the method, apparatus, non-transitory computer readable medium, and system described above (e.g., with reference to FIG. 8) further include detecting an object based on the state data. Some examples further include selecting the dynamical safety constraint from a plurality of safety constraint models based on the detected object.

At operation 900, the system receives state data for a reinforcement learning model interacting with an environment. In some cases, the operations of this step refer to, or may be performed by, a training component as described with reference to FIG. 4.

At operation 905, the system detects an object based on the state data. In some cases, the operations of this step refer to, or may be performed by, an object detector as described with reference to FIGS. 4 and 7.

At operation 910, the system selects the dynamical safety constraint from a set of safety constraint models based on the detected object. In some cases, the operations of this step refer to, or may be performed by, a safety system as described with reference to FIGS. 4 and 7.

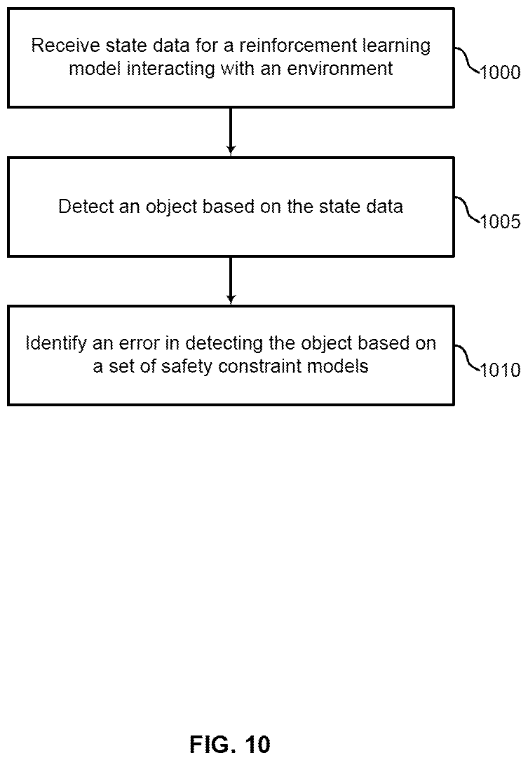

FIG. 10 shows an example of a process for identifying an error according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Some examples of the method, apparatus, non-transitory computer readable medium, and system described above (e.g., with reference to FIG. 8) further include detecting an object based on the state data. Some examples further include identifying an error in detecting the object based on a plurality of safety constraint models.

At operation 1000, the system receives state data for a reinforcement learning model interacting with an environment. In some cases, the operations of this step refer to, or may be performed by, a training component as described with reference to FIG. 4.

At operation 1005, the system detects an object based on the state data. In some cases, the operations of this step refer to, or may be performed by, an object detector as described with reference to FIGS. 4 and 7.

At operation 1010, the system identifies an error in detecting the object based on a set of safety constraint models. In some cases, the operations of this step refer to, or may be performed by, a safety system as described with reference to FIGS. 4 and 7.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described systems and methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving state data for a reinforcement learning model interacting with an environment;
detecting an object in the environment based on the state data;
updating a dynamical safety constraint corresponding to the object based on the state data; and
selecting an action based on the state data, the reinforcement learning model, and the dynamical safety constraint.

2. The method of claim 1, further comprising:
generating symbolic state data based on the state data, wherein the symbolic state data includes the detected object.

3. The method of claim 1, further comprising:
identifying a current location of the object on the state data; and
identifying a previous location of the object based on the state data, wherein the dynamical safety constraint is updated based on the current location and the previous location.

4. The method of claim 1, wherein:
the dynamical safety constraint is based on a safety constraint model representing motion of the object.

5. The method of claim 1, further comprising:
determining the dynamical safety constraint based on at least one of a plurality of safety constraint models associated with the object.

6. The method of claim 1, further comprising:
determining that the state data is inconsistent with a first safety constraint model; and
selecting a second safety constraint model for the dynamical safety constraint based on the determination.

7. The method of claim 1, further comprising:
determining that the state data is inconsistent with each of a plurality of candidate safety constraint models; and
identifying an error in detecting the object based on the determination.

8. The method of claim 1, further comprising:
receiving a plurality of candidate actions from the reinforcement learning model; and
eliminating an unsafe action from the plurality of candidate actions based on the dynamical safety constraint, wherein the action is selected from the plurality of candidate actions after eliminating the unsafe action.

9. The method of claim 1, further comprising:
determining that taking the action will result in improvement in updating the dynamical safety constraint, wherein the action is selected based on the determination.

10. The method of claim 1, further comprising:
computing a reward for the reinforcement learning model based on the state data; and
training the reinforcement learning model based on the reward.

11. An apparatus comprising:
a reinforcement learning model configured to receive state data and to select one or more actions based on the state data;
an object detector configured to generate symbolic state data based on the state data, the symbolic state data including an object; and
a safety system configured to update a dynamical safety constraint based on the symbolic state data and to filter the actions based on the dynamical safety constraint.

12. The apparatus of claim 11, further comprising:
an environmental sensor configured to monitor an environment and collect the state data.

13. The apparatus of claim 11, further comprising:
a tool configured to execute the actions to modify or navigate the environment.

14. The apparatus of claim 11, wherein:
the safety system comprises a domain expert configured to identify a set of object types and a set of safety constraint models associated with each of the object types.

15. The apparatus of claim 11, further comprising:
a learning acceleration component configured to select an action that can falsify a safety constraint model.

16. A method for training a neural network, the method comprising:
receiving state data for a reinforcement learning model interacting with an environment;
updating a dynamical safety constraint based on the state data;
selecting an action based on the state data, the reinforcement learning model, and the dynamical safety constraint;
computing a reward based on the action; and
training the reinforcement learning model based on the reward.

17. The method of claim 16, further comprising:
selecting a subsequent action based on accelerating learning of the dynamical safety constraint.

18. The method of claim 17, further comprising:
refraining from updating the reinforcement learning model based on the subsequent action.

19. The method of claim 16, further comprising:
detecting an object based on the state data; and
selecting the dynamical safety constraint from a plurality of safety constraint models based on the detected object.

20. The method of claim 16, further comprising:
detecting an object based on the state data; and
identifying an error in detecting the object based on a plurality of safety constraint models.
